(19) United States
(12) Patent Application Publication
(10) Pub. No.: US 2006/0238428 A1
(43) Pub. Date: Oct. 26, 2006

(54) Domed circuit board of an antenna amplifier for a vehicle antenna device

(76) Inventors: Christa Schmitt, Neckartenzlingen (DE); Boris Wischniowski, Stuttgart (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/549,832

(22) PCT Filed: Jan. 27, 2004
(86) PCT No.: PCT/EP04/00652

§ 371 Date: Jun. 20, 2006

(30) Foreign Application Priority Data
Mar. 19, 2003 (DE) 103121587

(51) Int. Cl. H01Q 1/32

(52) U.S. Cl. 343/713

(57) ABSTRACT

A high-frequency device for a vehicle antenna device which can be mounted on a surface of the vehicle, comprising a circuit board (1) with strip conductors and circuit components, in addition to feed means such as lines or connectors or the like. According to the invention, the circuit board (1) has at least one recess (2) extending crosswise in relation to a domed surface (3) for approximate equalization of said dome-shape.

### FIELD OF THE INVENTION

The inventions relates to a high-frequency device for a vehicular antenna according to the features of the introductory clause of claims 1.

### STATE OF THE ART

EP 1 080 513 describes an antenna amplifier serving as a high-frequency device for a vehicle antenna. This vehicle antenna has an antenna structure mounted on the windshield and having at its base contacts for electrical connection with circuit elements of a high-frequency device. With the known vehicle antenna the windshield is planar so that there is no problem mounting the circuit board by means of a nonconductive socket right on the windshield. The circuit board is formed of insulating material to which conductive traces and the necessary circuit elements are applied. Since the conductive traces are formed as a rule as a very thin layer of copper, there is the danger that the circuit paths will be broken and the device will malfunction as the circuit board is mounted on a curved surface rather than on a planar surface. A curved vehicle windshield is nowadays however standard, since the windshield must meet air-flow and design requirements. Thus if a high-frequency device that is premade and tested is mounted on such a curved windshield, the conductive traces break or the electronic parts on the circuit board are damaged, some times by rupture of the contact between the circuit elements and the conductive traces so that the high-frequency device malfunctions or does not operate at all. This has the disadvantage that signals (radio, television, and the like) cannot be received. It is also disadvantageous that signals to be transmitted over the antenna (as for instance cell-phone signals or emergency call) are also not sent.

### OBJECT OF THE INVENTION

It is an object of the invention to provide a high-frequency apparatus with a circuit board for a vehicle antenna that does not have the above-given disadvantages.

This object is attained by the features of claim 1.

According to the invention the circuit board has at least one recess extending transversely of a curved surface for fitting to the curvature. Dividing the circuit board into two or more parts ensures that the circuit board can be bent to conform to the curvature over its length without rupturing conductors or damaging the connections of circuit elements or even actually damaging the circuit elements. The number of recesses is dependent on the extent or curvature of the support surface so that several parallel grooves can be provided. in this manner the circuit board is subdivided into several interconnected parts that can be bent to conform to the curved support surfaces while each part remains planar as is necessary to make a circuit board. At the recesses, that can for example be made by milling, electrically conductive bridge conductors can be provided after the recesses are formed, which bridge conductors can compensate for positional differences before and after installation of the circuit board. The bridge conductors can be wires that are preferably stranded. In addition the conductive traces can be provided not on the side of the board into which the recesses are cut, but on the opposite side so that when the circuit board is bent for installation the conductive traces do not tear but instead are compressed somewhat. Such compression does not lead to rupturing of the circuit paths. The circuit element mounted on the circuit board are mounted adjacent the recesses so that there is always a clear spot left into which another recess can be milled. The depth of the recesses is determined by the curvature of the support surface and the thickness of the circuit board, the goal being to ensure sufficient bendability and a good connection fo the parts of the circuit board at the recesses.

The circuit board according to the invention has the advantage that it can be directly mounted on and secured to a curved support surface. This can be done by gluing the circuit board to the curved surface (in particular the vehicle windshield) with the connection to the antenna made before or at the same time as the glue mounting. Alternatively it is possible that the circuit board is mounted via spacers on the curved support surface. The spacers can be a plurality of small spacer bodies, as for instance sleeves or the like. The spacers should for example be made of nonconductive material (for example plastic) forming bases on or in which the circuit board is fitted. These bases can if necessary also serve for electrically connecting the contacts of the antenna with contacts of the circuit board.

In addition to the described contacts between the antenna and the circuit board, the circuit board can also have connectors, e.g. wires or sockets, via which the circuit elements are supplied power. At the same time these connectors feed signals to the high-frequency device and carry off signals received by the antenna and for example amplified by the on-board high-frequency device.

An embodiment of the invention, to which the invention is not limited, is described in the following with reference to the figures. Therein:

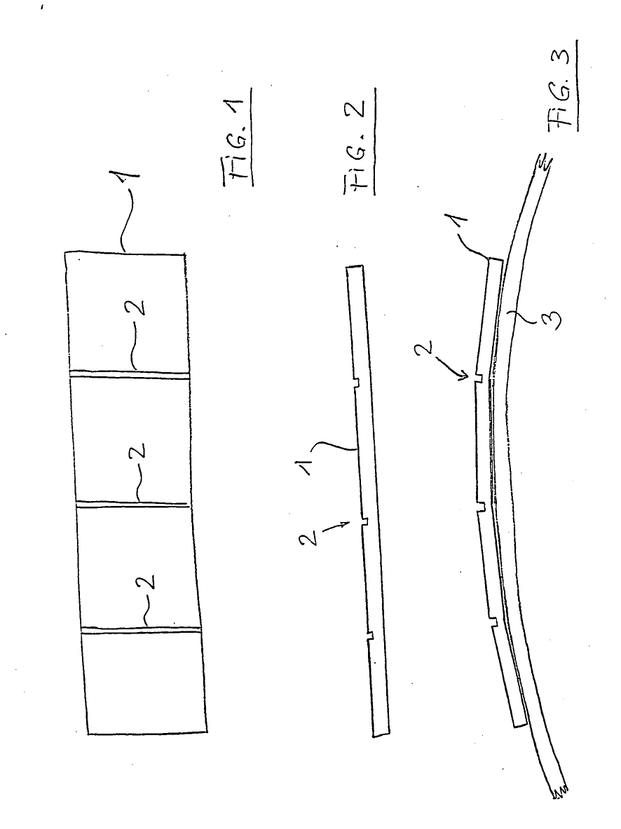

FIG. 1 is a top view of a circuit plate;

FIG. 2 is a section through the circuit plate;

FIG. 3 shows the mounting of the circuit plate directly on a vehicle windshield.

### EMBODIMENT OF THE INVENTION

FIG. 1 shows a circuit board 1 that for simplicity of illustration is shown without further elements such as circuit elements, connectors, and the like. This circuit board that is part of a high-frequency device, in particular of an antenna amplifier, for a vehicle antenna usually has an elongated rectangular shape. This is necessary since the high-frequency device with its circuit board is mounted underneath (toward the vehicle interior) of a vehicle windshield (in particularly of a rear window) so that it does not block the view through the windshield. For this reason only those edge regions are used for mounting the high-frequency device (in particular below the black strip or also for example near a brake light) so that the elongated shape of the circuit board 1 is necessary.

According to the invention the circuit board 1 is provided on one face with one or more recesses 2 that extend transversely to the longitudinal direction of the circuit board 1, the depth of the recesses 2 being dependent on the thickness of the circuit board 1 and the amount of curvature of the support surface. The depth is set such that the individual parts (regions between the recesses of the circuit board) on the one hand can be fitted to a curve and at the same time provide a stable connection between the individual parts.

FIG. 3 shows the mounting of the circuit board 1 on a curved surface 3 of the vehicle, here by way of example the vehicle windshield. Here also for simplification of illustration the way that the circuit board is fixed to the curved surface 3 (for example by glue or with the use of spacers) is not shown. It is clearly visible that, because of the recesses 2 in the circuit board 1, the circuit board 1 can conform along its length to the curved surface 3, even though at the same time its parts extend in planes so that the conductive traces and circuit elements on these parts do not have any problems. To this end it is important that there are no components in the regions of the recesses 2. If signals have to move between two parts, this can be done by appropriate bridge conductor conductors, it being possible that these bridge conductors are mounted on the planar circuit board 1 and soldered in place so that when the circuit board 1 is bent they conform to the curvature. At somewhat greater cost it is possible to provide sockets next to the recesses in which once the circuit board 1 is mounted on a curved surface bridge conductors can be fitted.

With respect to FIG. 3 it is also possible to mount the circuit board 1 underneath, not on top of the curved surface 3. Even here the recesses 1 can be on the side turned toward or away from the curved surface 3.

1. A high-frequency device for a vehicle antenna, mountable on a surface of a vehicle, and having a circuit board (1) with conductive traces and circuit elements and feed means like wires or sockets, characterized in that the circuit board (1) has at least one recess (2) extending transversely of a curved surface (3) for fitting to the curvature.

2. The high-frequency device according to claim 1, characterized in that the number of parallel recesses (2) depends on the amount of curvature of the surface.

3. The high-frequency device according to claim 1, characterized in that the recess (2) is made by milling.

4. The high-frequency device according to claim 1, characterized in that the circuit board (2) is directly mounted on and fixed to a curved surface (3).

5. The high-frequency device according to claim 1, characterized in that the circuit board (2) is fixed on the curved surface with interposition of spacers.

6. The high-frequency device according to claim 1, characterized in that the high-frequency device is an antenna amplifier.
